(19) United States
(12) Patent Application Publication
(10) Pub. No.: US 2013/0229781 A1
(43) Pub. Date: Sep. 5, 2013

(54) PHOTOGRAPHIC LIGHTING APPARATUS

(71) Applicant: Mark Langley, Macclesfield (GB)

(72) Inventor: Mark Langley, Macclesfield (GB)

(73) Assignee: MANFROTTO LIGHTING LIMITED, Surrey (GB)

(21) Appl. No.: 13/824,747

(22) PCT Filed: Sep. 16, 2011
(86) PCT No.: PCT/GB11/51746

§ 371 Date: May 17, 2013

(30) Foreign Application Priority Data
Sep. 20, 2010 (GB) 1015732.9

(51) Int. Cl. G03B 15/06

(52) U.S. Cl. CPC G03B 15/06
USPC 362/17

(57) ABSTRACT

A panel is disclosed that is both light transmissive and light reflective for use in photographic lighting apparatus. The panel comprises a light transmissive material and a light reflective material, which are arranged to provide a distribution of both light transmissive regions and light reflective regions across an operative surface of the panel.

### TECHNICAL FIELD

This invention relates to lighting apparatus for use in photography, and in particular to apparatus for reflecting or diffusing light.

### BACKGROUND

When illuminating the subject of a photograph, it is common to utilise apparatus for reflecting or diffusing light provided by a natural or artificial light source. In particular, a photographer may utilise one or more light reflectors and/or one or more light diffusers, which may be positioned to illuminate the subject.

Light reflectors typically comprise a panel that has a reflective surface on at least one side, and is adapted to reflect incident light from a natural or artificial light source towards the subject of the photograph. The reflective surface may be adapted to at least partially determine the colour and/or other properties of the light falling on the subject. Light reflectors are commonly hand-held, and the reflective surface is typically formed by a fabric sheet with a reflective coating.

Light diffusers typically comprise a translucent panel, which is adapted to transmit incident light from a natural or artificial light source through the panel, towards the subject of the photograph. The translucent panel is typically formed of a fabric sheet. The effect of the translucent panel is to “soften” the light falling on the subject.

A disadvantage suffered by conventional apparatus for reflecting or diffusing light is that conventional light reflectors cannot be used effectively as light diffusers, and conventional light diffusers cannot be used effectively as light reflectors. In particular, the materials conventionally used to provide effective reflective surfaces, such as metal foils, do not allow a significant amount of light, if any light, through the panel, and hence cannot also provide diffusion of incident light. Similarly, materials conventionally used to provide effective diffusion of light, such as woven fabrics, generally do not reflect a sufficient amount of light to provide effective reflection of light towards the subject.

Hence, a photographer is not able to use a single panel to reflect or diffuse light effectively, depending on the photographer's requirements. Instead, the photographer generally needs to carry both a light reflector and a light diffuser, or use apparatus that includes a light diffuser with a detachable reflective component.

### SUMMARY

There has now been devised improved photographic lighting apparatus, and an improved fabric panel for use in photographic lighting apparatus, which overcome or substantially mitigate the above-mentioned and/or other disadvantages associated with the prior art.

According to a first aspect of the invention, there is provided a panel that is both light transmissive and light reflective for use in photographic lighting apparatus, the panel comprising a light transmissive material and a light reflective material, which are arranged to provide a distribution of both light transmissive regions and light reflective regions across an operative surface of the panel.

According to a further aspect of the invention, there is provided photographic lighting apparatus comprising a panel as described above, which provides a distribution of both light transmissive regions and light reflective regions across an operative surface of the photographic lighting apparatus.

The panel and the photographic lighting apparatus according to the invention are advantageous principally because the provision of a distribution of both light transmissive regions and light reflective regions across an operative surface of the panel enables the operative surface of the panel to act as a light diffuser or a light reflector. In particular, the panel may be arranged to transmit light from a light source on one side of the panel, through the panel, towards a subject of the photograph on the other side of the panel. Alternatively, the panel may be arranged to reflect light from a light source on one side of the panel, towards the subject of the photograph on the same side of the panel.

The light transmissive regions are preferably formed of a translucent material, eg a fabric, which is preferably translucent in both directions through the panel. The translucent material is preferably white in colouration. Although the light transmissive regions will typically reflect some incident light, the proportion of light that is transmitted through these regions is greater than, and most preferably significantly greater than, the proportion of light that is reflected by these regions. Furthermore, the proportion of incident light that is reflected by the light transmissive regions will be less than, and most preferably significantly less than, the proportion of incident light that is reflected by the light reflective regions.

The light reflective regions are preferably formed of a reflective material, such as a metal, which may have the form of a coating applied to a suitable substrate. The light reflective regions may transmit some incident light through the panel, but the proportion of light that is reflected by these regions is greater than, and most preferably significantly greater than, the proportion of light that is transmitted through the panel by these regions. Furthermore, the proportion of incident light that is reflected by the light reflective regions will be greater than, and most preferably significantly greater than, the proportion of incident light that is reflected by the light transmissive regions. The light reflective regions may be adapted to at least partially determine the colour and/or other properties of the light illuminating the photographic subject. For example, the reflective surface may be of white, silver or gold colouration.

In a particularly advantageous arrangement, the light reflective and light transmissive panel comprises a substrate of light transmissive material, with a discontinuous coating of light reflective material applied to at least one side of the substrate. In this arrangement, the discontinuous coating of light reflective material preferably defines the light reflective regions, and the regions of the substrate that are exposed between the light reflective regions preferably define the light transmissive regions.

Although the light reflective and light transmissive panel will typically be flat in configuration, it may have other forms, eg the panel may have a curved configuration. Nevertheless, the light reflective and light transmissive panel preferably comprises a sheet of flexible material, which is most preferably held in tension in the photographic apparatus. In particular, the sheet of flexible material is preferably a fabric. The light reflective and light transmissive panel may be formed of a woven or knitted fabric. In presently preferred embodiments, the panel is formed of a tightly-woven fabric, such as polyester taffeta. The light reflective and light transmissive panel preferably has a smooth external surface, and may therefore include a plastics coating on its external surface. The plastics coating is preferably smooth in form.

The light reflective and light transmissive panel according to the invention preferably has two principal surfaces, at least one of which has a distribution of both light transmissive regions and light reflective regions. Most preferably, the regions between the light reflective regions are light transmissive regions, which are adapted to transmit light through the panel in either direction.

The light transmissive regions are preferably distributed sufficiently uniformly across the operative region of the panel, such that the arrangement of the light transmissive regions is not discernable in the lighting of the photographic subject. Similarly, light reflective regions are preferably distributed sufficiently uniformly across the operative region of the panel, such that the arrangement of the light reflective regions is not discernable in the lighting of the photographic subject.

The light transmissive regions and the light reflective regions are preferably intermixed over the operative surface of the panel. In a presently preferred embodiment, the light reflective regions comprise parallel strips, which are separated by parallel strips of light transmissive regions. Each strip preferably has a constant width. However, other intermixed arrangements are envisaged, such as a regular array of distinct light reflective regions, eg circles or squares, surrounded by a background of light transmissive material, or vice versa. In each arrangement, however, the distribution of light transmissive regions and/or light reflective regions is preferably substantially regular.

The proportion of light reflective surface relative to light transmissive surface is preferably chosen in accordance with the desired performance of the panel. The operative area of the light transmissive surfaces will typically be greater than the operative area of the light reflective surfaces, across an operative surface of the panel. In particular, an arrangement that has been found to provide effective diffusion, as well as an effective reflectance, for use in photography, comprises light reflective surfaces and light transmissive surfaces in a ratio of about 1:2, eg between 2:3 and 2:5.

In presently preferred embodiments, the light reflective material is present on one side of the panel only, such that the other side of the panel has a surface defined by the light transmissive material only. In this arrangement, the panel is able to provide two different reflective functions, and may also provide two different diffusion functions, depending upon the side of the panel to which light is incident. In particular, the panel is preferably arranged to provide a first reflectance to light incident on the side of the panel on which light reflective material is present, and a second reflectance to light incident on the side of the panel on which light reflective material is not present, the first reflectance being significantly greater than the second reflectance. Furthermore, the panel may also be arranged to provide a first transmittance of light incident on the side of the panel on which light reflective material is present, and a second transmittance of light incident on the side of the panel on which light reflective material is not present, the first transmittance being slightly less than the second transmittance.

The light reflective and light transmissive panel is preferably held under tension by a frame so as to form an operative panel of the photographic apparatus. In particular, the frame is preferably resilient, and preferably comprises a fabric tube to which the light reflective and/or light transmissive panel is fixed and a resilient hoop accommodated within the fabric tube. Preferably, the light reflective and light transmissive panel is not removable from the frame.

The light reflective and light transmissive panel may form part of hand-held photographic apparatus, eg a panel with a handle for the user. Alternatively, the light reflective and light transmissive panel may form part of photographic apparatus that is adapted to be fastened to support, or includes an integral support, such that the apparatus is positionable appropriately relative to the light source and the subject of the photograph.

### BRIEF DESCRIPTION OF THE DRAWINGS

Preferred embodiments of the invention will now be described in greater detail, by way of illustration only, with reference to the accompanying drawings, in which

FIG. 1 is a front view of photographic apparatus according to the invention;

FIG. 2 is a rear view of the photographic apparatus of FIG. 1;

FIG. 3 is a perspective view of the photographic apparatus of FIGS. 1 and 2; and

FIG. 4 is a fragmentary cross-sectional view along the line IV-IV in FIG. 2.

### DETAILED DESCRIPTION OF THE EMBODIMENTS

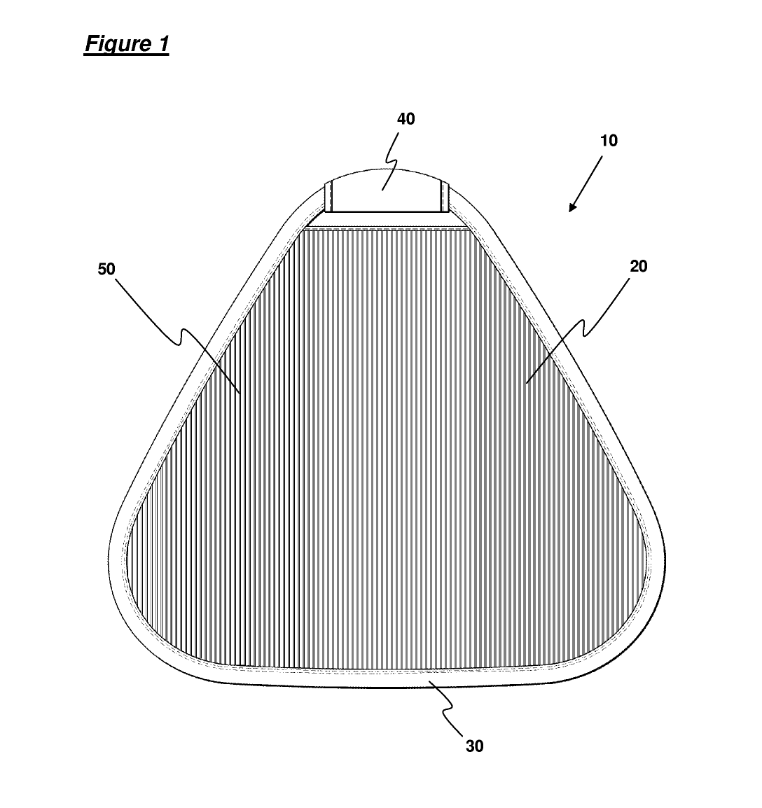

FIGS. 1 to 3 show a photographic device according to the invention, which is generally designated 10. The device 10 comprises a panel of flexible material 20 mounted within a resilient frame 30. The panel of flexible material 20 is formed of a tightly woven fabric in order to provide a smooth operative surface on each side.

The tightly woven fabric of the panel of flexible material 20 is formed of polyester taffeta, having a white colouration, which is adapted to transmit light therethrough. On one side of the panel 20, parallel strips of a reflective coating 50 are provided, and are adapted to reflect light incident thereon. The reflective coating in this embodiment is a metal, eg aluminium, coating, which is applied to the fabric in a transfer process.

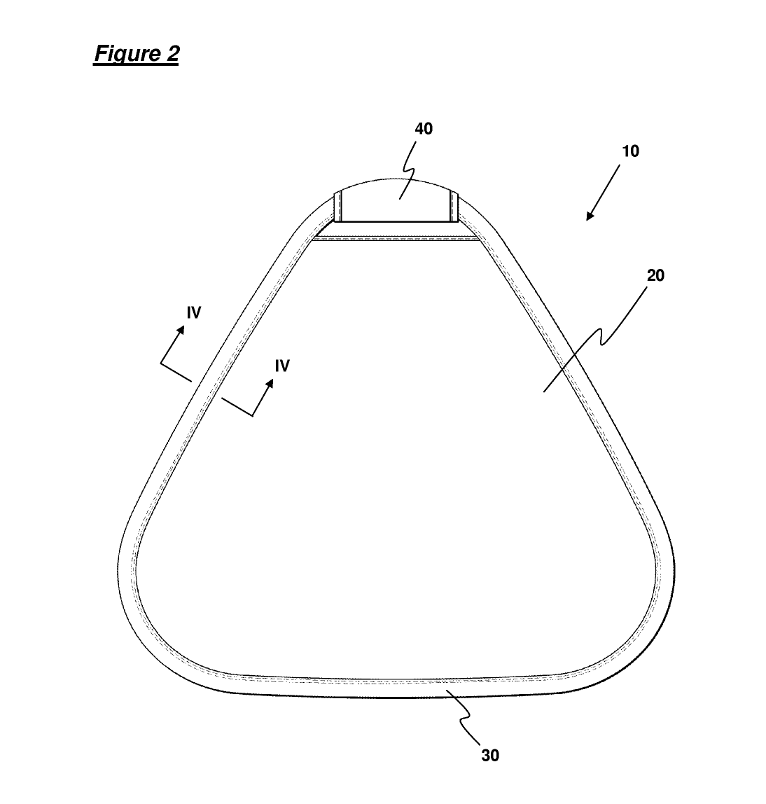

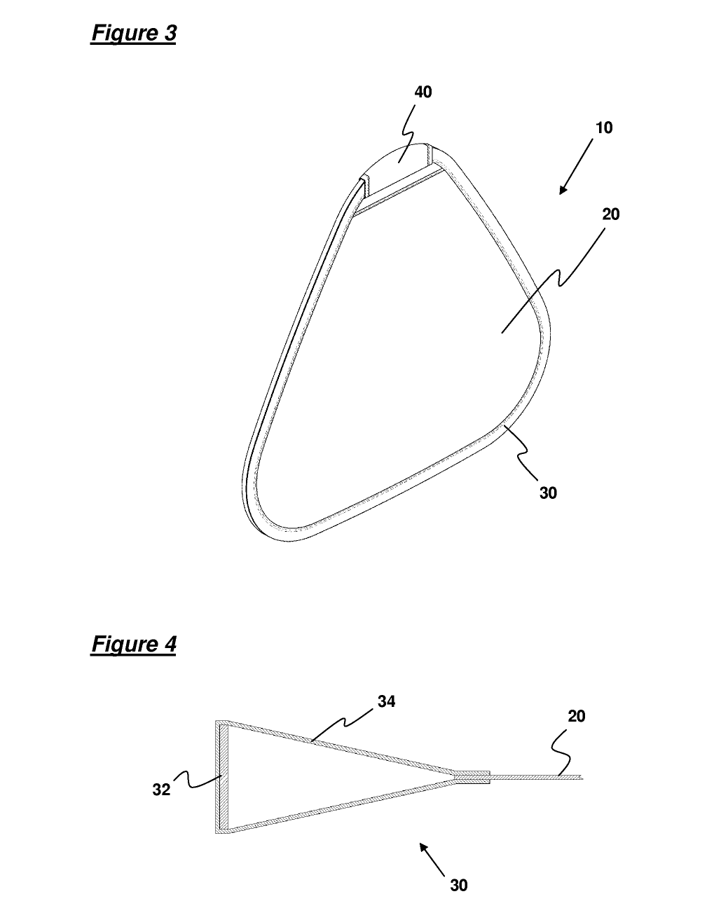

The arrangement of the strips of reflective coating 50 is shown most clearly in FIG. 1. The strips of reflective coating 50 have a regular separation (eg about 4 mm) and a regular width (eg 2 mm), and each define a light transmissive region of the panel 20. As shown in FIGS. 2 and 3, the other side of the panel does not carry any reflective coating, and hence is defined entirely by the fabric of the panel 20. Hence, the regions of the fabric between the strips of reflective coating 50 define light transmissive regions of the panel 20.

As shown in FIG. 4, the resilient frame 30 is formed by a fabric tube 34 stitched to the periphery of the panel 20, and a resilient hoop 32 within the fabric tube 34 that acts to maintain the panel 20 in tension. The hoop 32 is typically formed from a band of carbon spring steel having a width of about 10 mm and the ends of which are clipped, welded or riveted together to form the hoop. The panel 20 is shaped so that device is generally triangular in shape, but with significantly rounded corners, and the panel 20 is substantially free from wrinkles and creases.

In use, the side of the panel 20 that carries the strips of reflective coating 50 is able to reflect light incident thereon, towards a subject of a photograph. In addition, the panel 20 is able to transmit light incident on either side of the panel 20, through the panel towards a subject of a photograph, and cause diffusion of that light. The light transmittance of the panel 20 may differ depending upon the side of the panel on which light is incident, and hence the panel 20 may provide two different levels of diffusion performance. In addition, the side of the panel 20 that does not carry the strips of reflective coating 50 may be able to reflect a sufficient amount of light, towards a subject of a photograph, to be useful in some situations as a reflector. Hence, the photographic device 10 may provide two different reflective functions, and two different diffusion functions, depending upon the side of the panel 20 on which light is incident.

1. A panel that is both light transmissive and light reflective for use in photographic lighting apparatus, the panel comprising a light transmissive material and a light reflective material, which are arranged to provide a distribution of both light transmissive regions and light reflective regions across an operative surface of the panel.

2. A panel as claimed in claim 1, wherein the light transmissive regions are translucent, and adapted to diffuse light transmitted therethrough.

3. A panel as claimed in claim 1, wherein the panel comprises a substrate of light transmissive material, with a discontinuous coating of light reflective material applied to at least one side of the substrate.

4. A panel as claimed in claim 3, wherein the discontinuous coating of light reflective material defines the light reflective regions, and the regions of the substrate that are exposed between the light reflective regions define the light transmissive regions.

5. A panel as claimed in claim 1, wherein the light reflective and light transmissive panel comprises a sheet of flexible material.

6. A panel as claimed in claim 1, wherein the panel has two principal surfaces, at least one of which has a distribution of both light transmissive regions and light reflective regions.

7. A panel as claimed in claim 6, wherein the regions between adjacent light reflective regions are light transmissive regions, which are adapted to transmit light through the panel in either direction.

8. A panel as claimed in claim 1, wherein the light transmissive regions are distributed sufficiently uniformly across the operative region of the panel, such that the arrangement of the light transmissive regions is not discernable in the lighting of the photographic subject.

9. A panel as claimed in claim 1, wherein the light reflective regions are distributed sufficiently uniformly across the operative region of the panel, such that the arrangement of the light reflective regions is not discernable in the lighting of the photographic subject.

10. A panel as claimed in claim 1, wherein the light transmissive regions and the light reflective regions are intermixed over the operative surface of the panel.

11. A panel as claimed in claim 1, wherein the light reflective regions comprise parallel strips, which are separated by parallel strips of light transmissive regions.

12. A panel as claimed in claim 1, wherein the light reflective regions comprise a regular array of distinct light reflective regions, eg circles or squares, surrounded by a background of light transmissive material.

13. A panel as claimed in claim 1, wherein the light transmissive regions comprise a regular array of distinct light transmissive regions, eg circles or squares, surrounded by a background of light reflective material.

14. A panel as claimed in claim 1, wherein the light reflective material is present on one side of the panel only, such that the other side of the panel has a surface defined by the light transmissive material only.

15. A panel as claimed in claim 14, wherein the panel is able to provide two different reflective functions, depending upon the side of the panel to which light is incident.

16. A panel as claimed in claim 14, wherein the panel is able to provide two different diffusion functions, depending upon the side of the panel to which light is incident.

17. A panel as claimed in claim 1, wherein the panel comprises a sheet of flexible material held under tension by a frame, so as to be adapted to form an operative panel of photographic apparatus.

18. Photographic lighting apparatus comprising a panel as claimed in claim 1, which provides a distribution of both light transmissive regions and light reflective regions across an operative surface of the photographic lighting apparatus.

19. Photographic lighting apparatus as claimed in claim 18, wherein the light transmissive regions are translucent, and adapted to diffuse light transmitted therethrough.

20. Photographic lighting apparatus as claimed in claim 18, wherein the light reflective and light transmissive panel comprises a sheet of flexible material, which is held in tension in the photographic apparatus.
